(19) United States
(12) Patent Application Publication
(10) Pub. No.: US 2018/0266144 A1
(43) Pub. Date: Sep. 20, 2018

(54) LOCK MECHANISM

(71) Applicant: United States Postal Service, Washington, DC (US)

(72) Inventors: Robert E. Dalton, JR., Greenville, SC (US); William Albert Tartal, Baltimore, MD (US); Donald E. Irwin, Fredericksburg, VA (US); Michael L. Spears, Chantilly, VA (US)

(21) Appl. No.: 15/922,545

(22) Filed: Mar. 15, 2018

Related U.S. Application Data
(60) Provisional application No. 62/473,139, filed on Mar. 17, 2017.

(51) Int. Cl. E05B 17/20; E05B 17/16; E05B 65/52

(52) U.S. Cl. CPC E05B 17/20; E05C 1/004; E05B 65/523; E05B 17/16

(57) ABSTRACT

A lock having a plug installed within a housing. The plug can be securely retained within the housing using an attachment device disposed within the lockable volume. The attachment device can have a set screw and/or a pin to secure the attachment device to the plug and to prevent rotation of the attachment device.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of priority to U.S. Provisional Application No. 62/473,139, filed Mar. 17, 2017, the entire contents of which are hereby incorporated by reference.

### BACKGROUND

### Field

This application relates to the field of locks. Specifically, it relates to locks on doors to control access therethrough, such as access to lockable volumes which are configured to contain and enclose an item.

### SUMMARY

In one aspect described herein, a lock comprises a housing having a bore therethrough; a plug disposed within the bore, the plug comprising a first end and a second end, the first end comprising a key access slot and the second end comprising a securement feature; an attachment device configured to removably attach to the securement feature to retain the plug within the bore.

In some embodiments, the housing comprises a front surface and a rear surface and a retention surface formed on the rear surface, the second end of the plug being proximate the rear surface when the plug is disposed within the bore.

In some embodiments, the attachment device impinges on the retention surface when the attachment device is installed on the securement feature.

In some embodiments, the plug is retained within the bore due to the attachment device impinging on the retention surface when the attachment device is installed on the securement feature.

In some embodiments, the securement feature comprises a first thread formed around the second end of the plug; the attachment device has a ring shape with a second thread formed on the inner surface thereof; and the second thread of the attachment device mates with the first thread on the securement feature.

In some embodiments, the attachment device is formed having a hole therein, the hole extends radially outward through the attachment device; and the hole is configured to receive a set screw.

In some embodiments, the set screw extends through the hole formed in the attachment device, and the set screw impinges on the securement feature on the second end of the plug.

In some embodiments, the plug is formed having a pin hole formed in the second end, the pin hole extending axially through at least a portion of the plug along a length of the plug.

In some embodiments, the pin hole is configured to receive a biasing element and a pin, and wherein a first end of the pin extends at least partially out of the pin hole when installed within the pin hole.

In some embodiments, the attachment device further comprises at least one indentation formed therein.

In some embodiments, the first end of the pin fits into the at least one indentation formed in the attachment device when the attachment device is attached to the securement feature.

In some embodiments, the pin comprises a shoulder which impinges on a surface of the indentation due to a force exerted on the pin by the biasing element.

In some embodiments, the impingement of the shoulder on the surface of the indentation prevents movement of the attachment device relative to the securement feature.

In another aspect described herein, a method of installing a lock comprises inserting a plug into a bore formed in a housing, the plug having a first and a second end, the second end comprising a securement feature; attaching an attachment device to the securement feature, thereby retaining the plug within the housing.

In some embodiments, the housing comprises a first surface and a second surface, and a retention surface formed in the second surface; inserting the plug into the bore comprises inserting the plug such that the second end of the plug is proximate the rear surface; and retaining the plug within the housing comprises contacting the retention surface with the attachment device.

In some embodiments, the securement feature comprises a first thread formed around the second end of the plug; the attachment device is a ring shape and comprises a second thread formed on an inner surface thereof; and attaching the attachment device to the securement feature comprises mating the first thread with the second thread.

In some embodiments, the attachment device has a hole formed therein, the hole extending radially through the attachment device.

In some embodiments, the method further comprises inserting a set screw into the hole formed in the attachment device; and contacting the securement feature with an end of the set screw.

In some embodiments, the method further comprises inserting a biasing element and a pin into a pin hole formed in the second end of the plug; compressing the biasing element within the pin hole; attaching the attachment device to the securement feature; releasing the compression force on the biasing element; and contacting a first end of the pin to an indentation formed in the attachment device.

In some embodiments, the method further comprises preventing movement of the attachment device on the securement feature due to the interaction between the first end of the pin and the indentation formed in the attachment device.

### BRIEF DESCRIPTION OF THE DRAWINGS

FIG. 1 depicts a front perspective view of a lock having a plug-type locking mechanism disposed within a housing.

FIG. 2A depicts a perspective view of a plug-type locking mechanism for use in a lock.

FIG. 2B depicts a rear perspective view of an embodiment of a lock with a plug-type locking mechanism of FIG. 2A disposed therein.

FIG. 2C depicts a partial exploded view of the lock of FIG. 2B.

FIG. 3 depicts a partial exploded rear perspective view of an embodiment of a lock with a plug-type locking mechanism.

FIG. 4A depicts a perspective view of a plug-type lock mechanism.

FIG. 4B depicts a rear perspective view of an embodiment of a lock with a plug-type locking mechanism of FIG. 4A disposed therein.

FIG. 4C depicts a partial exploded view of the lock of FIG. 4B.

FIG. 4D depicts a close up view of a portion of FIG. 4C.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein and as illustrated in the figures, can be arranged, substituted, combined and designed in a wide variety of configurations, all of which are explicitly contemplated and made part of this disclosure.

Some embodiments disclosed herein relate generally to a lock. The lock can be configured to secure a lockable volume, such as, for example, a container or mailbox. The lock can be advantageously used on a multi-unit mailbox, such as on a community mailbox, a cluster box unit, a centralized mailbox, a parcel locker, and the like. Where a lock is used to secure a mailbox, it is desirable to ensure the integrity of the lock to keep safe the contents of the mailbox. Some plug-type locks have been defeated in mailbox applications. For example, some plugs have been removed from the doors or receptacles in which they are installed by pulling the plug out of the housing. When the plug is removed, the lock is defeated, and the mailbox can be freely opened, and items stolen from inside. Removal of the plug in this way is possible because there is an inadequate retaining mechanism for preventing removal of the plug. A plug-type lock having improved security and attack resistance is described herein.

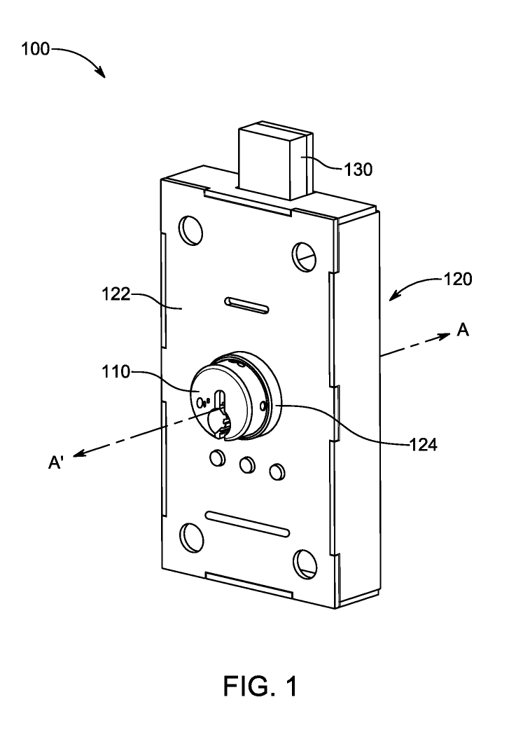

FIG. 1 depicts a front perspective view of a lock having a plug-type locking mechanism disposed within a housing. A lock 100 comprises a plug 110 and a housing 120. The plug 110 can be a plug-type locking mechanism that is operable with a key (not shown). The plug 110 is disposed within the housing 120. Components of the plug 110 interact with internal components of the housing as a key is inserted and turned to lock and unlock the lock 100. When the key is turned within the plug, components not shown in FIG. 1 interact with the housing 120 to move a bolt 130 between a first locked position and a second unlocked position. FIG. 1 depicts the bolt 130 in the first, locked position, when the bolt 130 extends from the housing 120. The bolt 130 will fit into a recess, slot, or gap in an enclosure, such as a frame in or surrounding the lockable volume of a receptacle, in order to secure the enclosure.

The housing 120 comprises a front surface 122 and a sleeve 124. The sleeve 124 is a circular or cylindrical extension which extends outward, from the front surface 122 in a direction generally perpendicular to the front surface 122. The sleeve 124 bounds or partially surrounds a void formed in the front surface 122. The inner diameter of the sleeve 124, and the void in the front surface 122, are sized to receive the plug 110. During installation of the plug 110, the plug 110 can be inserted into the sleeve 124 along the axis or line A-A′. When the lock 100 is used in an application, such as in a cluster box unit (CBU) or other similar application, a surface of the plug 110 is visible, and faces outward, while much of the housing 120 extending away from the front surface 122 is disposed within the lockable volume of the CBU.

In some embodiments, the housing 120 can be a universal housing that can receive a variety of plugs 110, each keyed to an individual key. For example, if a lock 100 malfunctions or is being upgraded, or otherwise changed, it is not necessary to replace the entire housing 120. The plug 110 can be removed, and a new plug 110 inserted into the sleeve 124. The new plug 110 is useable with a new key, and operating the new plug 110 with the new key will cause the new plug 110 to interact with components in the housing 120 to move the bolt 130. Replacing and retaining the plug 110 within the housing 120 will be described in greater detail below.

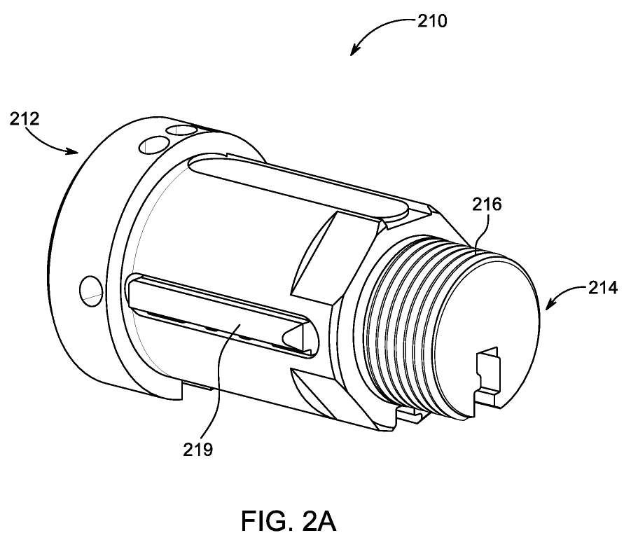

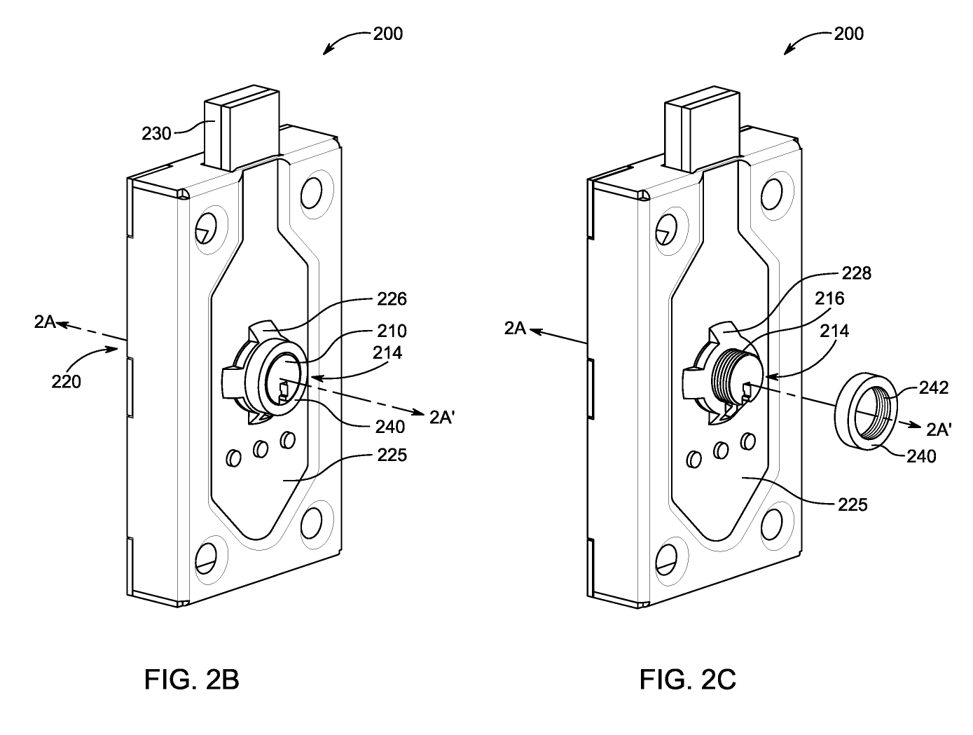

FIG. 2A depicts a perspective view of a plug-type locking mechanism for use in a lock. A plug 210 comprises a first end 212 and a second end 214 opposite the first end 212. The first end 212 is the end of the plug 210 which is configured to receive a key or unlocking device. The first end 212 is visible when the plug 210 is used in a housing for locking a lockable volume. The second end 214 comprises a securement feature 216, for example, threads. The securement feature 216 is configured to receive an attachment device (not shown) which can be removably attached to the securement feature 216. This feature will be described in greater detail below with regard to FIGS. 2B and 2C. The plug 210 further comprises a spring-biased protrusion 219 extending radially from the central axis of the plug 210. The spring-biased protrusion 219 is configured to fit within a corresponding slot in the sleeve 124, or within a component (not shown) within the housing 220, and prevents rotation of the plug 210 when the plug 210 is disposed within the housing 220.

FIG. 2B depicts a rear perspective view of an embodiment of a lock with a plug-type locking mechanism of FIG. 2A disposed therein. A lock 200 comprises the plug 210, a housing 220, a bolt 230, and an attachment device 240. When the attachment device 240 is not installed, such as during maintenance or replacement, the plug 210 can be moved into and out of the housing along the line 2A-2A′. The housing 220 and the bolt 230 can be similar to the housing and bolt described above with regard to FIG. 1.

The housing further comprises a rear surface 225. When the lock 200 is used in connection with a lockable volume, such as a CBU, the rear surface 225 is not visible unless the lockable volume is opened. When the lock 200 is locked, and the lockable volume is not accessible, the rear surface 225 is disposed within the lockable volume, and is not accessible from outside the CBU. The rear surface 225 is disposed opposite and generally parallel to a first surface (not visible), which is similar to that described elsewhere herein. The rear surface 225 is formed with a void therein configured to receive the second end 214 of the plug 210. The void in the rear surface 225 is at least partially surrounded by a collar 226. The collar 226 is integrally formed with the housing 220. In some embodiments, the collar 226 can be welded, screwed, riveted, glued, or otherwise affixed to the rear surface 225. The collar 226 may comprise one or more retention surfaces 228. As shown in FIG. 2C, the retention surface 228 is a continuous surface surrounding or defining the void in the rear surface 225, and surrounding the securement feature 216 in the second end 214 of the plug 210. However, in some embodiments, the retention surface 228 can comprise one or more discrete surfaces disposed at least partially around the void in the rear surface 225.

FIG. 2C depicts a partial exploded view of the lock of FIG. 2B. The attachment device 240 is shown separated from the plug 210. The attachment device 240 has an internal surface 242 which is configured to mate with the securement feature 216 on the second end 214 of the plug 210. For example, as depicted, the internal surface 242 comprises threads, and the securement feature 216 comprises threads complementary to the threads on the internal surface 242. The attachment device can thread onto the securement feature 216, and the attachment device 240 and be in close proximity to the retention surface 228. The close proximity between the attachment device 240 and the retention surface 228 prevents the plug 200 from being removed from the housing along the line 2A-2A′. In some embodiments, the attachment device 240 can contact or impinge on the retention surface 228. The contact between the internal surface 242 threads and the threads on the securement feature 216 securely attaches the plug 210 to the housing 220 to prevent withdrawal of the plug 210 from the housing 220 along line 2A-2A′. In some embodiments, the attachment device 240 can have a thread sealant applied thereto which will seal the threads of the attachment device 240 to the threads of the securement feature 216. In some embodiments, the lock 200 can further include a lock washer, or deformable metal component that is deformed when the attachment device 240 is secured to the securement feature 216. In some embodiments, the deformable metal component can be disposed between the retention surface and the attachment device. These features can be used to make removal of the attachment device 240 more difficult or to provide tamper evidence.

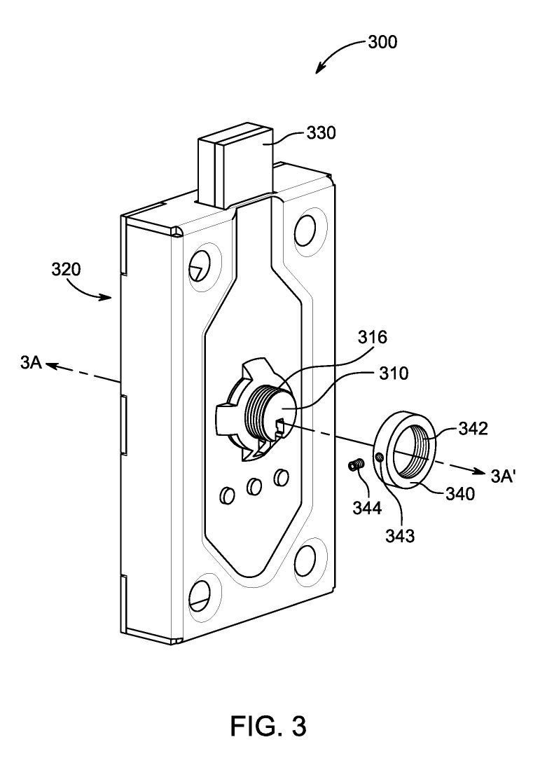

FIG. 3 depicts a partial exploded rear perspective view of an embodiment of a lock with a plug-type locking mechanism. A lock 300 comprises a plug 310, a housing 320 and a bolt 330. These features can be similar to those described elsewhere herein. The plug 310 can be inserted and removed from the housing along line 3A-3A′ during replacement or maintenance. The plug 310 comprises a securement feature 316 that can include a threaded surface. The securement feature 316 is configured to receive an attachment device 340, which comprises an internal threaded surface 342. The attachment device 340 can further be formed having a hole 343 formed therein. The hole 343 can extend radially from a central axis of the attachment device 340 through the material of the attachment device 340. The inner surface of the hole 343 can comprise a threaded surface. The inner surface of the hole 343 can have a diameter and shape adapted to receive a set screw 344. The set screw 344 can be inserted into the hole 343 and can impinge on the securement feature 316. The contact between the set screw 344 and the securement feature 316 can provide resistance to rotational movement of the attachment device 340 and removal of the attachment device 340.

In some embodiments, the securement feature 316 can further comprise an indent or hole (not shown) to receive a portion of the set screw 344 as it is inserted into the attachment device 340. The attachment device 340, when installed on the securement feature 316 prevents the plug 310 from being removed from the housing 320 when the lock 300 is in use on a lockable volume, and provides improved security and tamper-resistance.

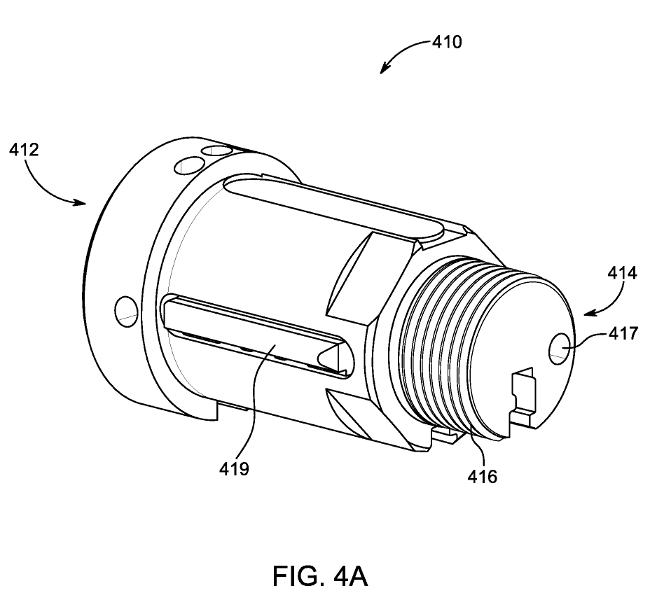

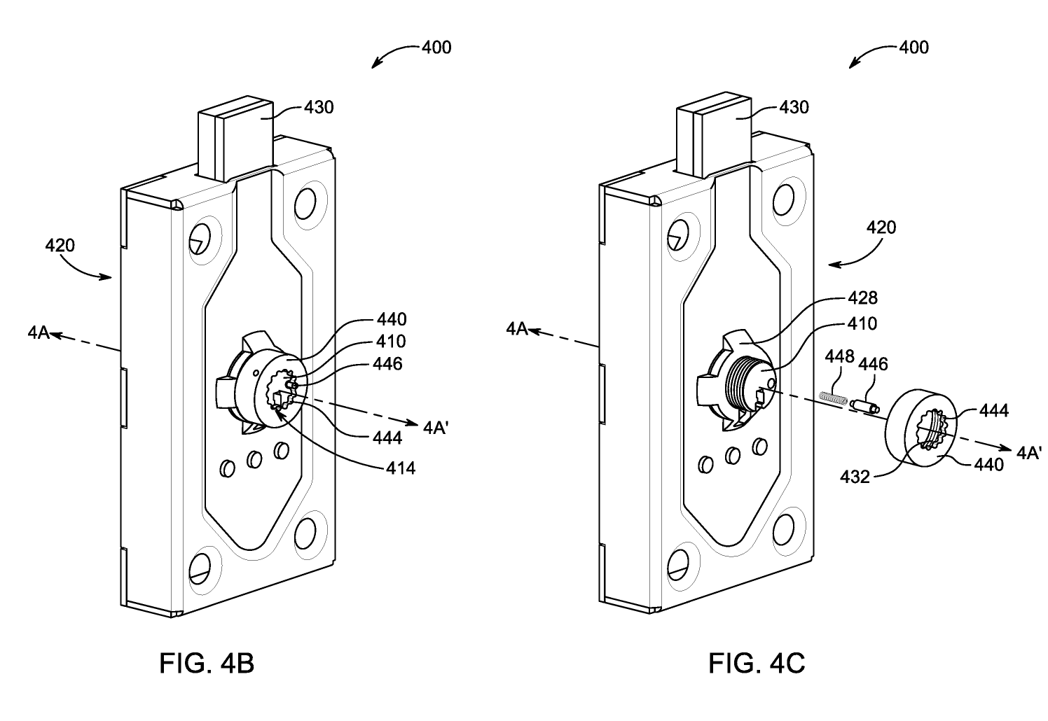

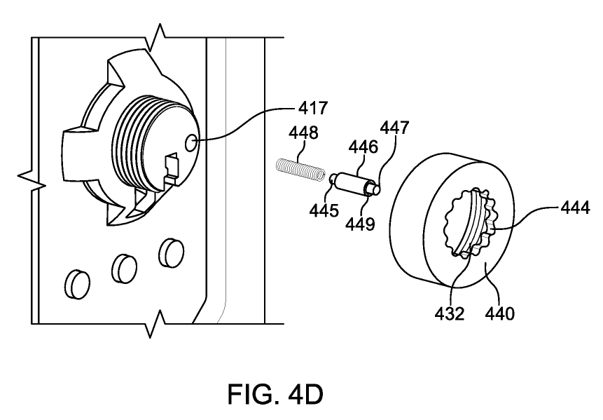

FIG. 4A depicts a perspective view of a plug-type lock mechanism. A plug 410 comprises a first end 412 and a second end 414, a securement feature 416, and a spring-biased protrusion 419, all of which can be similar to those described elsewhere herein. The plug 410 can further comprise a pin hole 417 formed in the second end 414. The pin hole 417 can be a void formed in the body of the plug 410, and extend axially through at least a portion of the plug 410 along a length of the plug. As shown in FIGS. 4B and 4C, the pin hole 417 can extend along or parallel to the line designated 4A-4A′.

FIG. 4B depicts a rear perspective view of an embodiment of a lock with a plug-type locking mechanism of FIG. 4A disposed therein. The plug 410 is disposed within a housing 420, and can be inserted into the housing 420 in the direction depicted by line 4A-4A′. The plug 410 can interact with a locking mechanism and internal components of the housing 420 (not shown) to move the bolt 430, similar to those described elsewhere herein.

The lock 400 comprises an attachment device 440 configured to removably attach to the securement feature 416 and to establish close contact to a retention surface 428 (visible in FIG. 4C) to prevent unauthorized removal of the plug 410 from the housing 420.

FIG. 4C depicts a partial exploded view of the lock of FIG. 4B. Referring to FIG. 4C, the attachment device 440 has an internal surface 432 which can comprise threads, and one or more indentations 444. The one or more indentations are formed extending radially inward from the internal surface 432. In some embodiments, where there are a plurality of indentations 444, the indentations 444 can be formed circumferentially around a central axis of the attachment device 440 which is aligned with line 4A-4A′.

The lock 400 further comprises a pin 446 and a spring 448. The pin 446 and the spring 448 are configured to fit in the pin hole 417 formed in the second end 414 of the plug 410 so that their longitudinal axes are aligned with the longitudinal axis of the pin hole 417. The spring 448 is disposed within the pin hole 417. The pin 446 is inserted into the pin hole 417 and compresses the spring 448 as the pin 446 is inserted. When the attachment device 440 is attached to the securement feature 416, the attachment device 440 retains the pin 446 and the spring 448 within the pin hole 417. This process is described in greater detail with regard to FIG. 4D.

FIG. 4D depicts a close up view of a portion of FIG. 4C. The pin 446 comprises a tip 447 and a shoulder 449. The tip 447 is integrally formed with the pin 446, and has a smaller diameter or radius than the pin 446. The shoulder 449 is formed where the smaller diameter tip 447 meets the larger diameter portion of the pin 446. In some embodiments, the pin 446 further comprises an end 445 which also has a reduced diameter relative to the main body of the pin 446. The end 445 can be sized to partially fit within an end of the spring 448 to securely retain the pin 446 in the spring 448, for example, during installation or removal of the pin 446. The tip 447 can have a radius or diameter complementary to or the same as the radius of the one or more indentations 444 on the attachment device 440.

To install the attachment device 440 on the plug 410, the spring is first inserted to the pin hole 417, and the pin 446 is inserted into the pin hole 417, which partially compresses the spring 448. Using a tool (not shown) designed to keep the pin 446 in the pin hole 417 so as not to extend significantly out of the pin hole 417, the pin 446 is pushed into the pin hole 417 against the resistance of the spring 448. With the pin 446 in the pin hole 417, the attachment device 440 is attached to the securement feature 416. For example, the attachment device 440 can be threaded onto the securement feature 416. When the attachment device 440 is secured on the securement feature 416, the tool is removed, and the force keeping the pin 446 pushed into the pin hole 417 is thus removed. The spring 448 will force the pin 446 at least partially out of the pin hole 417. The tip 447 of the pin 446 extends into one of the one or more indentations 444. The shoulder 449 impinges on an underside of the one or more indentations 444 preventing further movement of the pin 446 out of the pin hole 417. Because the radius of the indentations 444 is smaller than the radius of the body of the pin 446, the shoulder 449 impinges on the underside of the indentations 444, and the pin 446 is retained at least partially within the pin hole 417, with the tip 447 extending into one of the indentations 444 on the inner rim of the inner surface 432. The radial surface of the indentations 444 cooperates with the outer radial surface of the tip 447 to prevent rotation of the attachment device 440.

To rotate the attachment device 440 with the pin 446 installed, a specifically adapted tool must be used to push the pin 446 farther into the pin hole 417 against the resistance of the spring 448, and not interfere with the indentations 444 on the attachment device 440. When the pin 446 is pushed into the pin hole 417 enough that the tip 449 is no longer engaged with one of the one or more indentations 444, the attachment device can be rotated and/or removed. When the pin 446 is installed, the attachment device will resist rotation due to the interaction between the pin 446, specifically the tip 447 of the pin 446, and the indentations 444. With the tip 447 of the pin 446 disposed within a radius of one of the indentations 444, the pin 446 will keep the attachment device 440 in place. This provides resistance to rotation and tampering, as the attachment device 440 is unlikely to become loose over time, and the plug 410 will resist rotation within the housing 420.

In some embodiments, the features depicted in FIG. 3 and those in FIGS. 4A-4D can be combined in one lock. For example, the lock 400 can include an attachment device 440 having indentations 444, a pin 446, and the like, as well as a hole formed therein which can receive a set screw, as described with regard to FIG. 3.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

A person skilled in the art will recognize that each of these sub-systems can be inter-connected and controllably connected using a variety of techniques and hardware and that the present disclosure is not limited to any specific method of connection or connection hardware.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A lock comprising:
a housing having a bore therethrough;
a plug disposed within the bore, the plug comprising a first end and a second end, the first end comprising a key access slot and the second end comprising a securement feature;
an attachment device configured to removably attach to the securement feature to retain the plug within the bore.

2. The lock of claim 1, wherein the housing comprises a front surface and a rear surface and a retention surface formed on the rear surface, the second end of the plug being proximate the rear surface when the plug is disposed within the bore.

3. The lock of claim 2, wherein the attachment device impinges on the retention surface when the attachment device is installed on the securement feature.

4. The lock of claim 3, wherein the plug is retained within the bore due to the attachment device impinging on the retention surface when the attachment device is installed on the securement feature.

5. The lock of claim 1, wherein the securement feature comprises a first thread formed around the second end of the plug;
wherein the attachment device has a ring shape with a second thread formed on the inner surface thereof;
and wherein the second thread of the attachment device mates with the first thread on the securement feature.

6. The lock of claim 1, wherein the attachment device is formed having a hole therein, the hole extending radially outward through the attachment device; the hole configured to receive a set screw.

7. The lock of claim 6, wherein the set screw extends through the hole formed in the attachment device, and the set screw impinges on the securement feature on the second end of the plug.

8. The lock of claim 1, wherein the plug is formed having a pin hole formed in the second end, the pin hole extending axially through at least a portion of the plug along a length of the plug.

9. The lock of claim 1, wherein the pin hole is configured to receive a biasing element and a pin, and wherein a first end of the pin extends at least partially out of the pin hole when installed within the pin hole.

10. The lock of claim 9, wherein the attachment device further comprises at least one indentation formed therein.

11. The lock of claim 10, wherein the first end of the pin fits into the at least one indentation formed in the attachment device when the attachment device is attached to the securement feature.

12. The lock of claim 11, wherein the pin comprises a shoulder which impinges on a surface of the indentation due to a force exerted on the pin by the biasing element.

13. The lock of claim 12, wherein the impingement of the shoulder on the surface of the indentation prevents movement of the attachment device relative to the securement feature.

14. A method of installing a lock comprising:
inserting a plug into a bore formed in a housing, the plug having a first and a second end, the second end comprising a securement feature;
attaching an attachment device to the securement feature, thereby retaining the plug within the housing.

15. The method of claim 14, wherein the housing comprises a first surface and a second surface, and a retention surface formed in the second surface;
wherein inserting the plug into the bore comprises inserting the plug such that the second end of the plug is proximate the rear surface; and
wherein retaining the plug within the housing comprises contacting the retention surface with the attachment device.

16. The method of claim 14, wherein:
the securement feature comprises a first thread formed around the second end of the plug;
wherein the attachment device is a ring shape and comprises a second thread formed on an inner surface thereof;
and wherein attaching the attachment device to the securement feature comprises mating the first thread with the second thread.

17. The method of claim 16, wherein the attachment device has a hole formed therein, the hole extending radially through the attachment device.

18. The method of claim 17, further comprising:
inserting a set screw into the hole formed in the attachment device; and
contacting the securement feature with an end of the set screw.

19. The method of claim 14, further comprising:
inserting a biasing element and a pin into a pin hole formed in the second end of the plug;
compressing the biasing element within the pin hole;
attaching the attachment device to the securement feature;
releasing the compression force on the biasing element; and
contacting a first end of the pin to an indentation formed in the attachment device.

20. The method of claim 19, further comprising preventing movement of the attachment device on the securement feature due to the interaction between the first end of the pin and the indentation formed in the attachment device.
